(19) United States
(12) Patent Application Publication
(10) Pub. No.: US 2026/0140351 A1
(43) Pub. Date: May 21, 2026

(54) ZOOM LENS AND IMAGE PICKUP APPARATUS

(71) Applicant: CANON KABUSHIKI KAISHA, Tokyo (JP)

(72) Inventor: Yuki SHINZATO, Saitama (JP)

(21) Appl. No.: 19/383,857

(22) Filed: Nov. 10, 2025

(30) Foreign Application Priority Data
Nov. 18, 2024 (JP) 2024-201184

(51) Int. Cl. G02B 13/00; G02B 7/02; G02B 15/14

(52) U.S. Cl. CPC G02B 13/009; G02B 7/025; G02B 13/0045; G02B 13/006; G02B 15/1465

(57) ABSTRACT

A zoom lens includes, in order from an object side to an image side, a first lens unit with negative refractive power, a second lens unit, one or more intermediate lens units, and a rear lens unit. At least the second lens unit and the one or more intermediate lens units move during zooming. Each distance between adjacent lens units changes. The one or more intermediate lens units include an N-th intermediate lens unit disposed closest to an image plane, and the N-th intermediate lens unit includes a shift unit with positive refractive power disposed closest to the image plane and movable in a direction orthogonal to an optical axis of the zoom lens.

### BACKGROUND

### Field of the Technology

The aspect of the disclosure relates to one or more embodiments of a zoom lens for imaging and an image pickup apparatus having the same.

### Description of the Related Art

Some zoom lenses include a shift unit that moves (shifts) in a direction orthogonal to the optical axis for image stabilization and the like. The shift unit is demanded to have a reduced size, weight, moving amount in order to reduce the load on the actuator that drives it. Japanese Patent Application Laid-Open No. 2021-196449 discloses a zoom lens that includes a shift unit and performs zooming by moving a plurality of lens units.

### SUMMARY

A zoom lens according to one aspect of the disclosure includes, in order from an object side to an image side, a first lens unit with negative refractive power, a second lens unit, one or more intermediate lens units, and a rear lens unit. At least the second lens unit and the one or more intermediate lens units move during zooming and each distance between adjacent lens units changes. The one or more intermediate lens units include an N-th intermediate lens unit disposed closest to an image plane, and the N-th intermediate lens unit includes a shift unit with positive refractive power disposed closest to the image plane and movable in a direction orthogonal to an optical axis of the zoom lens. The following inequalities may be satisfied:

$$1.8 \leq fis / ( - f 1 ) \leq 4.8$$

$$0.05 \leq BFw / fw \leq 1.29$$

where f1 is a focal length of the first lens unit, fis is a focal length of the shift unit, fw is a focal length of the zoom lens at a wide-angle end, and BFw is an air-equivalent distance on the optical axis from a lens surface closest to the image plane of the zoom lens at the wide-angle end to the image plane. Alternatively, the shift unit may include two or more lenses or the second lens unit may include two or more lens elements and the following inequalities are satisfied:

$$1.8 \leq fis / ( - f 1 ) \leq 4.8$$

$$0.05 \leq BFw / fw \leq 1.85 .$$

An image pickup apparatus according to another aspect of the disclosure includes the above zoom lens.

Features of the present disclosure will become apparent from the following description of embodiments with reference to the attached drawings. The following description of embodiments is described by way of example.

### BRIEF DESCRIPTION OF THE DRAWINGS

FIG. 1 illustrates sectional views of a zoom lens according to Example 1 at a wide-angle end, intermediate zoom position, and telephoto end.

FIGS. 2A, 2B, and 2C illustrate aberration diagrams of the zoom lens according to Example 1 at the wide-angle end, the intermediate zoom position, and the telephoto end, respectively.

FIG. 3 illustrates sectional views of a zoom lens according to Example 2 at a wide-angle end, intermediate zoom position, and telephoto end.

FIGS. 4A, 4B, and 4C illustrate aberration diagrams of the zoom lens according to Example 2 at the wide-angle end, the intermediate zoom position, and the telephoto end, respectively.

FIG. 5 illustrates sectional views of a zoom lens according to Example 3 at a wide-angle end, intermediate zoom position, and telephoto end.

FIGS. 6A, 6B, and 6C illustrate aberration diagrams of the zoom lens according to Example 3 at the wide-angle end, the intermediate zoom position, and the telephoto end, respectively.

FIG. 7 is a sectional view of a zoom lens according to Example 4 at a wide-angle end, intermediate zoom position, and telephoto end.

FIGS. 8A, 8B, and 8C are aberration diagrams of the zoom lens according to Example 4 at the wide-angle end, the intermediate zoom position, and the telephoto end, respectively.

FIG. 9 is a sectional view of a zoom lens according to Example 5 at a wide-angle end, intermediate zoom position, and telephoto end.

FIGS. 10A, 10B, and 10C are aberration diagrams of the zoom lens according to Example 5 at the wide-angle end, the intermediate zoom position, and the telephoto end, respectively.

FIG. 11 is a sectional view of a zoom lens according to Example 6 at a wide-angle end, intermediate zoom position, and telephoto end.

FIGS. 12A, 12B, and 12C are aberration diagrams of the zoom lens according to Example 6 at the wide-angle end, the intermediate zoom position, and the telephoto end, respectively.

FIG. 13 is a schematic diagram of an image pickup apparatus having the zoom lens according to any one of Examples 1 to 6.

### DESCRIPTION OF THE EMBODIMENTS

A description will be given of examples according to the disclosure with reference to the drawings. First, before Examples 1 to 6 are described, matters common to each example will be described.

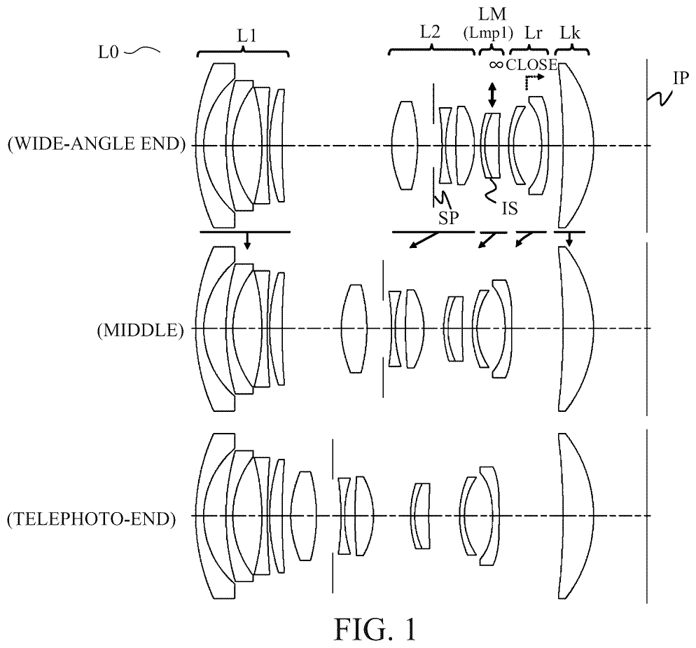

FIGS. 1, 3, 5, 7, 9, and 11 illustrate cross sections of zoom lenses L0 according to Examples 1 to 6 in an in-focus state on an object at infinity (referred to as “in an in-focus state at infinity” hereinafter) at a wide-angle end, intermediate zoom position (MIDDLE), and telephoto end, respectively. The zoom lens according to each example is used as imaging optical systems in a variety of image pickup apparatuses, such as digital video cameras, digital still cameras, broadcasting cameras, film-based cameras, surveillance cameras, and on-board cameras (in-vehicle cameras).

In each figure, a left side is an object side and a right side is an image side. SP represents an aperture stop (diaphragm), which determines a light beam at the open F-number (Fno) (maximum aperture). IP represents an image plane of the zoom lens L0. An imaging surface (light-receiving surface) of an image sensor such as a CCD sensor or CMOS sensor, or a film surface (photosensitive surface) of a silver film is disposed on the image plane IP.

The zoom lens L0 according to each example is designed to allow for distortion, and image distortion caused by distortion is corrected by image processing performed by the image pickup apparatus using information on the distortion amount.

The zoom lens L0 according to each example may also be used as a projection optical system in an image projection apparatus such as a projector. In this case, a left side of the figure is a screen side (enlargement side), and a right side is a display element side (reduction side).

In a zoom lens, a lens unit is a group of one or more lenses that may or may not move as a unit during magnification variation (zooming) between the wide-angle end and the telephoto end. In other words, each distance between adjacent lens units changes during zooming. In each figure, a solid arrow below a lens unit that moves during zooming indicates a moving locus of each lens unit during zooming from the wide-angle end to the telephoto end. The wide-angle end and the telephoto end respectively indicate zoom states of the maximum angle of view (shortest focal length) and the minimum angle of view (longest focal length) when the lens unit that moves during zooming is located at both ends of the mechanically or controllably movable range on the optical axis. The group of one or more lenses that moves during focusing is a focus lens unit, and a dotted arrow above the focus lens unit in each figure indicates a moving direction of the focus lens unit during focusing from infinity to a close distance. The lens unit may also include an aperture stop SP. In this example, the term “lens element” refers to a single lens or a cemented lens formed by cementing together a plurality of lenses.

The zoom lens L0 according to each example includes, in order from the object side to the image side, a first lens unit L1 with negative refractive power, a second lens unit L2, an intermediate group LM including one or more intermediate lens units, and a rear (subsequent) lens unit Lr. The intermediate group LM includes an N-th intermediate lens unit disposed closest to the image plane among the intermediate group LM. An image stabilizing unit IS with positive refractive power is disposed closest to the image plane among the N-th intermediate lens unit. The image stabilizing unit IS is a shift unit that moves in a direction orthogonal to the optical axis of the zoom lens L0 to compensate for image blur caused by camera shake, such as hand shake. Movement in the direction orthogonal to the optical axis includes movement within a plane orthogonal to the optical axis, as illustrated by the up and down arrows in each figure, and movement in a direction that includes a component orthogonal to the optical axis (for example, rotation around a point on the optical axis). The shift unit may also move in a direction orthogonal to the optical axis for purposes other than image stabilization, such as tracking a moving object.

In the zoom lens L0 according to each example, the second lens unit L2 and the intermediate group LM (intermediate lens unit) may move toward the object during zooming from the wide-angle end to the telephoto end. The second lens unit L2 may have positive refractive power, and the intermediate group LM may have positive refractive power as a whole. A zoom function can be achieved by moving the second lens unit L2 and the intermediate group LM, both of which have positive refractive powers, closer to the first lens unit L1 with negative refractive power.

The second lens unit L2 may include two or more lens elements. Thereby, spherical aberration, coma, and other aberrations can be satisfactorily corrected.

The N-th intermediate lens unit may have positive refractive power, and move toward the object while increasing a distance to the second lens unit L2 during zooming from the wide-angle end to the telephoto end. Thereby, curvature of field can be corrected, a moving amount of the N-th intermediate lens unit can be reduced, and the size and weight of the N-th intermediate lens unit can be reduced. As a result, the load on the actuator that drives the N-th intermediate lens unit during zooming can be reduced, and fast and quiet zooming can be achieved.

Since the compact and lightweight N-th intermediate lens unit includes the image stabilizing unit IS, the size and weight of an image stabilizing mechanism including the actuator that drives the image stabilizing unit IS can also be reduced. In particular, the image stabilizing unit IS disposed closest to the image plane among the N-th intermediate lens unit can further reduce the size and weight of the image stabilizing unit IS. Thereby, the drive load during zooming can be reduced and excellent image stabilization functionality can be achieved.

The image stabilizing unit IS may include two or more lenses, such as one positive lens and one negative lens, or a cemented lens (counted as two lenses) in which one positive lens and one negative lens are cemented together to form a single lens element. Thereby, fluctuations in chromatic aberration that occur during image stabilization can be suppressed. In order to reduce the size of the entire zoom lens L0, the N-th intermediate lens unit may have a single image stabilizing unit IS.

The zoom lens L0 according to each example may satisfy the following inequalities (1) and (2):

$$1.8 \leq fis / ( - f 1 ) \leq 4.8 \qquad ( 1 )$$

$$0.05 \leq BFw / fw \leq 1.85 \qquad ( 2 )$$

In inequalities (1) and (2), fl is a focal length of the first lens unit L1, and fis is a focal length of the image stabilizing unit IS. fw is a focal length of the zoom lens L0 at the wide-angle end. BFw is an air-equivalent distance (back focus) on the optical axis from a lens surface closest to the image plane IP of the zoom lens L0 to the image plane IP at the wide-angle end.

Inequality (1) defines a proper relationship between the focal length of the first lens unit L1 and the focal length of the image stabilizing unit IS. In a case where fis/(−f1) becomes higher than the upper limit of inequality (1), the power of the image stabilizing unit IS is reduced, and thus a moving amount for image stabilization and the size of the image stabilization mechanism increase. In addition, in a case where the power of the first lens unit L1 increases, it becomes difficult to effectively correct off-axis aberrations such as curvature of field. In a case where fis/(−f1) becomes lower than the lower limit of inequality (1), the power of the image stabilizing unit IS increases, and thus it becomes difficult to correct aberrations such as decentering coma during image stabilization, and sufficient image stabilization performance cannot be achieved. In a case where the power of the first lens unit L1 is reduced, the moving amount of the image stabilizing unit IS (N-th intermediate lens unit) during zooming increases, and the size of the zoom lens L0 increases.

Inequality (2) defines a proper relationship between the back focus of the zoom lens L0 at the wide-angle end and the focal length of the zoom lens L0 at the wide-angle end. In a case where BFw/fw becomes higher than the upper limit of inequality (2), the overall optical length of the zoom lens L0 (a distance from a lens surface closest to the object to the image plane IP) increases. In a case where BFw/fw becomes lower than the lower limit of inequality (2), a flange back in the image pickup apparatus cannot be sufficiently secured, and it becomes difficult to place the shutter, etc.

Satisfying the above configuration and inequalities can achieve a zoom lens L0 that has a reduced size, high optical performance, and high image stabilization performance, while reducing the size and weight and the moving amount of the image stabilizing unit IS.

The lower limit of inequality (1) may be set to 1.93, 2.17, or 2.35, and the upper limit of inequality (1) may be set to 3.58, 3.28, or 3.05. The lower limit of inequality (2) may be set to 0.20, 0.30, or 0.55, and the upper limit of inequality (2) may be set to 1.55, 1.29, or 1.15. Inequality (2) be replaced with the following inequality (2a):

$$0.05 \leq BFw / fw \leq 1.29 \qquad ( 2 a )$$

The zoom lens L0 according to each example may further have the following configuration: In the zoom lens L0 according to each example, the first lens unit L1 is fixed relative to the image plane IP during zooming. The weight of the first lens unit L1 is likely to increase due to the large outer diameter of the lens in the first lens unit L1. Thus, the first lens unit L1 fixed during zooming can achieve quick and quiet zooming. In addition, the first lens unit L1 fixed during zooming can suppress tilt of the first lens unit L1 that occurs during zooming, and improve optical performance.

In the zoom lens L0 according to each example, the first lens unit L1 may include, in order from the object side to the image side, two meniscus lenses (a first meniscus lens and a second meniscus lens) that have negative refractive power and are convex toward the object side. Thereby, the zoom lens L0 can have a high zoom magnification on the wide-angle side and satisfactorily correct off-axis aberrations such as curvature of field.

In the zoom lens L0 according to each example, the first lens unit L1 may include two or more lenses including one negative lens and one positive lens. Thereby, aberration can be satisfactorily corrected. Satisfactorily correcting off-axis aberrations such as chromatic aberration and curvature of field that occur in the first lens unit L1, which does not move during zooming, can reduce the number of lenses required for aberration correction in the second lens unit L2, intermediate group LM, and rear lens unit Lr, which move during zooming. As a result, the sizes and weights of the lens units that move during zooming can be reduced. A positive lens may be disposed closest to the image plane in the first lens unit L1 particularly in terms of chromatic aberration correction.

In the zoom lens L0 according to each example, the second lens unit L2 may include a maximum aperture stop SP, because it is possible to reduce the size and weight of moving lens units, such as the lenses in the second lens unit L2 disposed near the maximum aperture stop SP and the intermediate group LM including the N-th intermediate lens unit. As a result, this configuration can provide multiple lenses necessary for aberration correction while reducing the load on the actuator that drives the moving lens units during zooming, thereby achieving good aberration performance while increasing the zoom magnification.

In the zoom lens L0 according to each example, the N-th intermediate lens unit may include three or fewer lenses. This configuration can suppress the heavy weight of the N-th intermediate lens unit, which includes an image stabilizing mechanism, and thereby reduce the load on the actuator that drives the N-th intermediate lens unit during zooming.

In the zoom lens L0 according to each example, the second lens unit L2 with positive refractive power may include one aspherical lens having a lens surface shape whose refractive power weakens from the optical axis toward the periphery. Thereby, the overall length of the zoom lens L0 can be reduced and spherical aberration, coma, and other aberrations that occur particularly at the telephoto end can be satisfactorily corrected.

In the zoom lens L0 according to each example, all of the second lens unit L2, the intermediate group LM, and the rear lens unit Lr may move toward the object during zooming from the wide-angle end to the telephoto end. This configuration allows for a high zoom magnification while effectively suppressing aberration fluctuations during zooming. The number of moving lens units that move during zooming may be four or less. Thereby, the overall size of the zoom lens can be restrained from increasing when each moving lens unit is driven by an electric actuator.

In the zoom lens L0 according to each example, the rear lens unit Lr may have negative refractive power, and be disposed on the image side of and adjacent to the second lens unit L2 and the intermediate group LM, each of which has positive refractive power. Such a telephoto-type power arrangement can reduce the overall length of the zoom lens L0.

In the zoom lens L0 according to each example, an object-side lens surface of a lens element disposed closest to the object in the rear lens unit Lr may have a convex shape toward the object. This configuration can suppress fluctuations in spherical aberration that occur during zooming. The lens element disposed closest to the object in the rear lens unit Lr may have a meniscus shape with negative refractive power and a convex shape toward the object. The rear lens unit Lr may be used as a focus lens unit that moves toward the image plane during focusing from infinity to a close distance. This configuration can achieve focusing with suppressed fluctuations in aberrations such as spherical aberration and curvature of field.

A final lens unit Lk with positive refractive power that does not move during zooming may be disposed closest to the image plane in the zoom lens L0 according to each example. In a case where the zoom lens L0 is used as an electric zoom lens for a lens interchangeable type camera, the robustness of the zoom lens L0 can be improved by placing a fixed lens unit closest to the image plane so as to prevent direct access to the moving lens unit from the outside. A lens unit with positive refractive power disposed closest to the image plane can reduce an incident angle of an off-axis ray relative to the image sensor disposed on the image plane IP. As a result, shading that occurs in the peripheral area of the image can be suppressed.

The zoom lens L0 according to each example may satisfy at least one of the following inequalities (3) to (8):

$$0.9 \leq fN / ( - f 1 ) \leq 4.5 \qquad ( 3 )$$

$$0.4 \leq ( 1 - β ist ) \times β isrt \leq 1.45 \qquad ( 4 )$$

$$0.4 \leq \vert MN / M 2 \vert \leq 1.2 \qquad ( 5 )$$

$$3.5 \leq TTLw / fw \leq 8. 9 \qquad ( 6 )$$

$$1. \leq fis / f 2 \leq 4.5 \qquad ( 7 )$$

$$0.54 \leq f 2 / ( - f 1 ) \leq 2.35 \qquad ( 8 )$$

In inequalities (3) to (8), f2 is a focal length of the second lens unit L2, fN is a focal length of the N-th intermediate lens unit, and βist is the lateral magnification of the image stabilizing unit (shift unit) IS at the telephoto end. βisrt is the lateral magnification of an optical system including all lenses disposed closer to the image plane than the image stabilizing unit IS at the telephoto end. M2 is a moving amount of the second lens unit L2 during zooming from the wide-angle end to the telephoto end, and MN is a moving amount of the N-th intermediate lens unit during zooming from the wide-angle end to the telephoto end. A moving amount of a lens unit is a difference between its position at the wide-angle end and its position at the telephoto end, and does not include a reciprocal moving amount. It is positive when the lens unit is disposed closer to the image plane at the telephoto end than at the wide-angle end, and negative when it is disposed closer to the object at the telephoto end than at the wide-angle end. TTLw is an overall optical length, calculated by adding the air-equivalent distance (BFw) on the optical axis from a lens surface of zoom lens L0 closest to the image plane to the image plane at the wide-angle end to a distance on the optical axis from a lens surface of zoom lens L0 closest to the object to a lens surface closest to the image plane of zoom lens L0 at the wide-angle end.

Inequality (3) defines a proper relationship between the focal length of the first lens unit L1 and the focal length of the N-th intermediate lens unit. In a case where fN/(−f1) becomes higher than the upper limit of inequality (3), the power of the N-th intermediate lens unit is reduced, and the moving amount of the N-th intermediate lens unit during zooming increases. In addition, in a case where the power of the first lens unit L1 increases, it becomes difficult to properly correct off-axis aberrations such as curvature of field. In a case where fN/(−f1) becomes lower than the lower limit of inequality (3), the power of the N-th intermediate lens unit increases and it becomes difficult to properly correct aberrations. In addition, in a case where the power of the first lens unit L1 is reduced, the moving amount of the moving lens unit during zooming and the size of the zoom lens L0 increase.

The lower limit of inequality (3) may be set to 1.32, 1.61, or 1.80, and the upper limit of inequality (3) may be set to 3.58, 3.28, or 3.05.

Inequality (4) defines a proper range for the image shift sensitivity TS of the image stabilizing unit IS at the telephoto end. Image shift sensitivity TS is a ratio (TS=ΔI/ΔL) of a moving amount ΔL of the image stabilizing unit IS in a direction orthogonal to the optical axis to a moving amount ΔI of the optical image (imaging position) on the image plane IP in a direction orthogonal to the optical axis. In a case where (1−βist)×βisrt becomes higher than the upper limit of inequality (4), the power of the image stabilizing unit IS increases, and it becomes difficult to correct aberrations such as decentering coma during image stabilization and image stabilization performance becomes insufficient. In a case where (1−βist)×βisrt becomes lower than the lower limit of inequality (4), the image shift sensitivity TS of the image stabilizing unit IS is reduced, and the moving amount of the image stabilizing unit IS for image stabilization and thus the size of the image stabilizing mechanism increase.

The lower limit of inequality (4) may be set to 0.55, 0.60, or 0.67, and the upper limit of inequality (4) may be set to 1.21, 1.10, or 0.97.

Inequality (5) defines a proper relationship between the moving amount of the second lens unit L2 and the moving amount of the N-th intermediate lens unit during zooming from the wide-angle end to the telephoto end. In a case where |MN/M2| becomes higher than the upper limit of inequality (5), the moving amount of the N-th intermediate lens unit during zooming increases, and suppression of aberration fluctuations such as curvature of field becomes insufficient. In a case where |MN/M2| becomes lower than the lower limit of inequality (5), the moving amount of the N-th intermediate lens unit for a high zoom magnification during zooming cannot be sufficiently secured, or the moving amount of the second lens unit L2 during zooming increases.

The lower limit of inequality (5) may be set to 0.54, 0.61, or 0.65, and the upper limit of inequality (5) may be set to 0.95, 0.87, or 0.82.

Inequality (6) defines a proper relationship between the overall optical length of the zoom lens L0 at the wide-angle end and the focal length of the entire zoom lens L0 system at the wide-angle end. In a case where TTLw/fw becomes higher than the upper limit of inequality (6), the size of the zoom lens L0 increases. In a case where TTLw/fw becomes lower than the lower limit of inequality (6), it becomes difficult to provide sufficient space to arrange the lenses for sufficient aberration correction.

The lower limit of inequality (6) may be set to 3.87, 4.36, or 4.75, and the upper limit of inequality (6) may be set to 8.23, 7.88, or 7.30.

Inequality (7) defines a proper relationship between the focal length of the second lens unit L2 and the focal length of the image stabilizing unit IS. In a case where fis/f2 becomes higher than the upper limit of inequality (7), the power of the image stabilizing unit IS is reduced, and the moving amount of the image stabilizing unit IS for image stabilization and thus the size of the image stabilizing mechanism increase. In addition, in a case where the power of the second lens unit L2 increases, it becomes difficult to satisfactorily correct on-axis aberrations such as spherical aberration. In a case where fis/f2 becomes lower than the lower limit of inequality (7), the power of the image stabilizing unit IS increases, it becomes difficult to correct aberrations such as decentering coma during image stabilization, and sufficient image stabilization performance cannot be obtained. In addition, in a case where the power of the second lens unit L2 is reduced, the moving amount of the second lens unit L2 during zooming and thus the size of the zoom lens L0 increase.

The lower limit of inequality (7) may be set to 1.50 or 2.00, and the upper limit of inequality (7) may be set to 3.50, 2.96, or 2.75.

Inequality (8) defines a proper relationship between the focal lengths of the first lens unit L1 and the second lens unit L2. In a case where f2/(−f1) becomes higher than the upper limit of inequality (8), the power of the first lens unit L1 increases, and it becomes difficult to correct off-axis aberrations such as curvature of field that occur in the first lens unit L1 in the wide-angle scheme. In addition, in a case where the power of the second lens unit L2 is reduced, it becomes difficult to acquire a proper zoom ratio. In a case where f2/(−f1) becomes lower than the lower limit of inequality (8), the power of the first lens unit L1 is reduced, and the outer diameter of the first lens unit L1 increases in the wide-angle scheme. In addition, in a case where the power of the second lens unit L2 increases, it becomes difficult to correct on-axis aberrations such as spherical aberration.

The lower limit of inequality (8) may be set to 0.75, 0.85, or 0.90, and the upper limit of inequality (8) may be set to 1.90 or 1.50.

Next, the detailed configurations of the zoom lenses L0 according to Examples 1 to 6 will be described. After Example 6, numerical examples 1 to 6 corresponding to Examples 1 to 6, respectively, will be illustrated.

### Example 1

A zoom lens L0 according to Example 1 (numerical example 1) illustrated in FIG. 1 includes, in order from the object side to the image side, a first lens unit L1 with negative refractive power, a second lens unit L2 with positive refractive power including an aperture stop SP, a first intermediate lens unit Lmp1 with positive refractive power, a rear lens unit Lr with negative refractive power, and a final lens unit Lk with positive refractive power. The intermediate group LM includes the first intermediate lens unit Lmp1, and the N-th intermediate lens unit is the first intermediate lens unit Lmp1.

During zooming, the first lens unit L1 and the final lens unit Lk are fixed relative to the image plane IP. During zooming from the wide-angle end to the telephoto end, all of the second lens unit L2, the first intermediate lens unit Lmp1, and the rear lens unit Lr move monotonically toward the object side. During focusing from infinity to a close distance, the rear lens unit Lr moves toward the image side. The first intermediate lens unit Lmp1 including its element disposed closest to the image plane serves wholly as an image stabilizing unit IS and moves in a direction orthogonal to the optical axis.

The first lens unit L1 includes four lens elements, which include, in order from the object side to the image side, a first negative meniscus lens convex toward the object side, a second negative meniscus lens convex toward the object side, a biconcave negative lens, and a positive meniscus lens convex toward the object side. The second lens unit L2 includes the aperture stop SP and three lens elements. More specifically, the second lens unit L2 includes, in order from the object side to the image side, a biconvex positive lens with aspheric surfaces on both sides, the aperture stop SP, a biconcave negative lens, and a biconvex positive lens.

The first intermediate lens unit Lmp1 includes, in order from the object side to the image side, a single lens element that is a positive cemented lens formed by cementing together a negative meniscus lens convex toward the object side and a positive meniscus lens convex toward the object side. The rear lens unit Lr includes two lens elements, which include, in order from the object side to the image side, a negative meniscus lens convex toward the object side, and a negative meniscus lens with aspheric surfaces on both sides and convex toward the image side. The final lens unit Lk includes a single lens element that is a positive meniscus lens convex toward the image side.

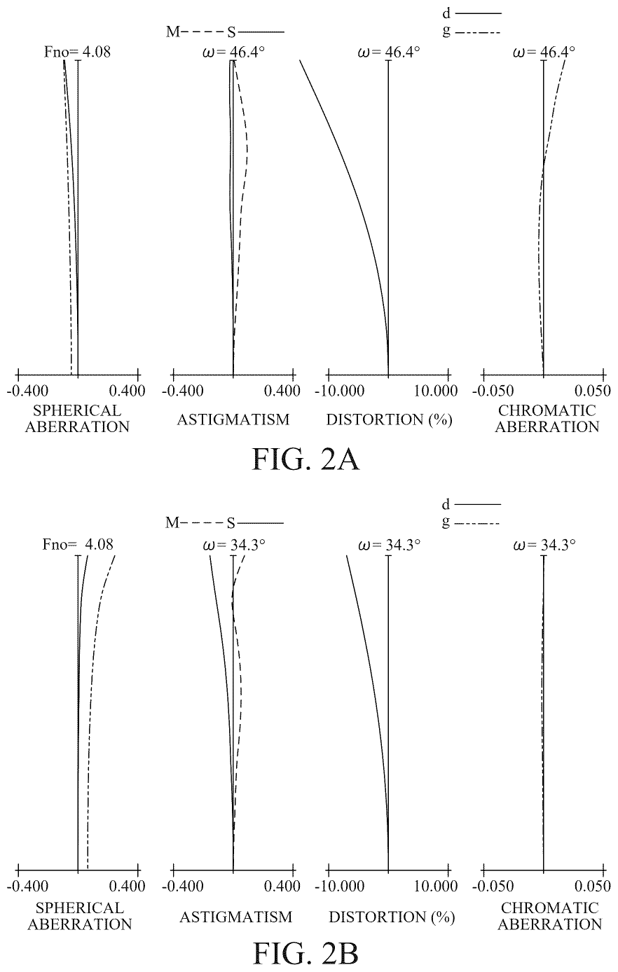

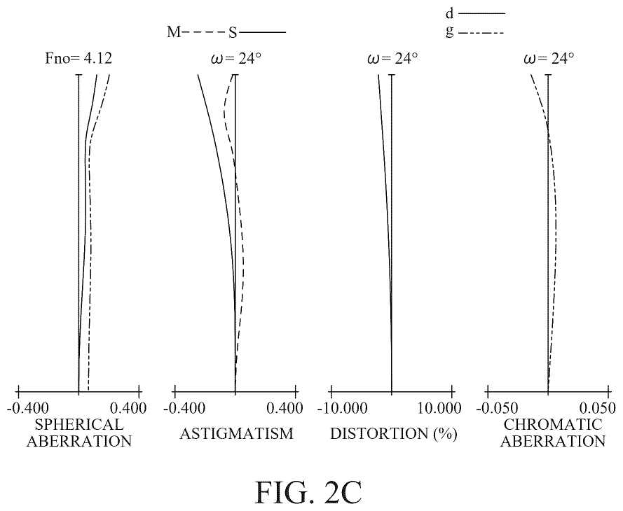

FIGS. 2A, 2B, and 2C illustrate the longitudinal aberrations (spherical aberration, astigmatism, distortion, and chromatic aberration) of the zoom lens L0 according to numerical example 1 at the wide-angle end in the in-focus state at infinity. In the spherical aberration diagram, Fno indicates the F-number. A solid line indicates a spherical aberration amount for the d-line (wavelength 587.6 nm), and an alternate long and two short dashes line indicates a spherical aberration amount for the g-line (wavelength 435.8 nm). In the astigmatism diagram, a solid line S indicates an astigmatism amount on a sagittal image plane, and a broken line M indicates an astigmatism amount on a meridional image plane. The distortion diagram illustrates a distortion amount for the d-line. The chromatic aberration diagram illustrates a lateral chromatic aberration amount for the g-line. @ is a half angle of view) (°. The above description of the aberration diagrams is applicable to the aberration diagrams of other numerical examples.

### Example 2

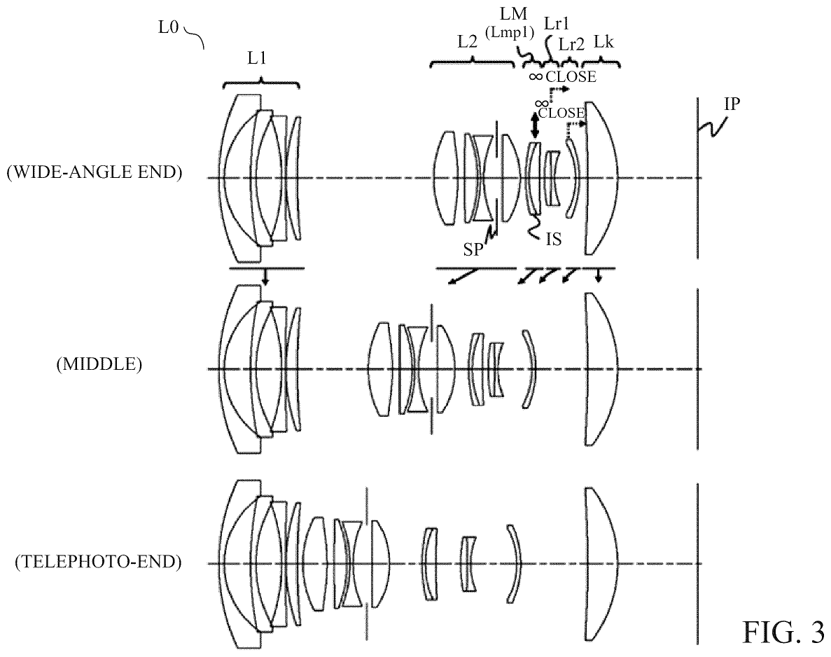

A zoom lens L0 according to Example 2 (numerical example 2) illustrated in FIG. 3 includes, in order from the object side to the image side, a first lens unit L1 with negative refractive power, a second lens unit L2 with positive refractive power including an aperture stop SP, a first intermediate lens unit Lmp1 with positive refractive power, a first rear lens unit Lr1 with negative refractive power, a second rear lens unit Lr2 with negative refractive power, and a final lens unit Lk with positive refractive power. The intermediate group LM includes the first intermediate lens unit Lmp1, and the N-th intermediate lens unit is the first intermediate lens unit Lmp1.

During zooming, the first lens unit L1 and the final lens unit Lk are fixed relative to the image plane IP. During zooming from the wide-angle end to the telephoto end, all of the second lens unit L2, the first intermediate lens unit Lmp1, the first rear lens unit Lr1, and the second rear lens unit Lr2 move monotonically toward the object side. In this example, the rear lens unit is divided into two, the first rear lens unit Lr1 and the second rear lens unit Lr2, and during focusing from infinity to a close distance, the first rear lens unit Lr1 and the second rear lens unit Lr2 move toward the image side on different loci. The first intermediate lens unit Lmp1 including its element disposed closest to the image plane serves wholly as an image stabilizing unit IS and moves in a direction orthogonal to the optical axis.

The first lens unit L1 includes four lens elements, which include, in order from the object side to the image side, a first negative meniscus lens having an aspheric surface on the image side and convex toward the object side, a second negative meniscus lens having a convex shape toward the object side, a biconcave negative lens, and a positive meniscus lens having a convex shape toward the object side. The second lens unit L2 includes the aperture stop SP and four lens elements. More specifically, the second lens unit L2 includes, in order from the object side to the image side, a biconvex positive lens having aspheric surfaces on both sides, a biconvex positive lens, a biconcave negative lens, the aperture stop SP, and a positive plano-convex lens having an aspheric surface on the image side and convex toward the image side.

The first intermediate lens unit Lmp1 includes a single lens element that is a positive cemented lens formed by cementing together a negative meniscus lens having a convex shape toward the object side and a positive meniscus lens having a convex shape toward the object side, arranged in order from the object side to the image side. The first rear lens unit Lr1 includes a single lens element that is a negative cemented lens formed by cementing together a biconvex positive lens and a biconcave negative lens, arranged in order from the object side to the image side. The second rear lens unit Lr2 includes a single lens element that is a negative meniscus lens convex toward the image side. The final lens unit Lk includes a single lens element that is a positive meniscus lens convex toward the image side.

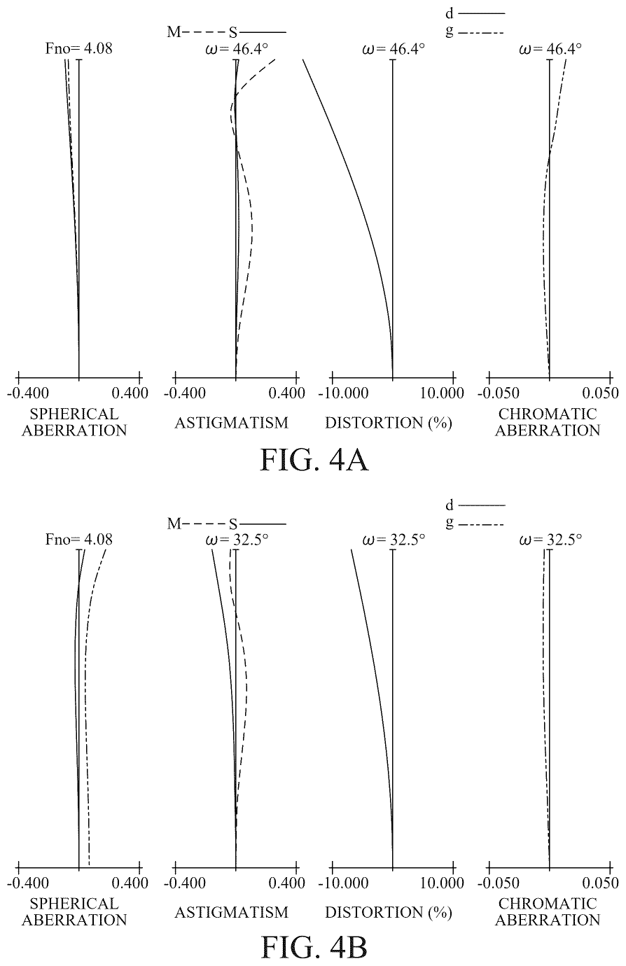

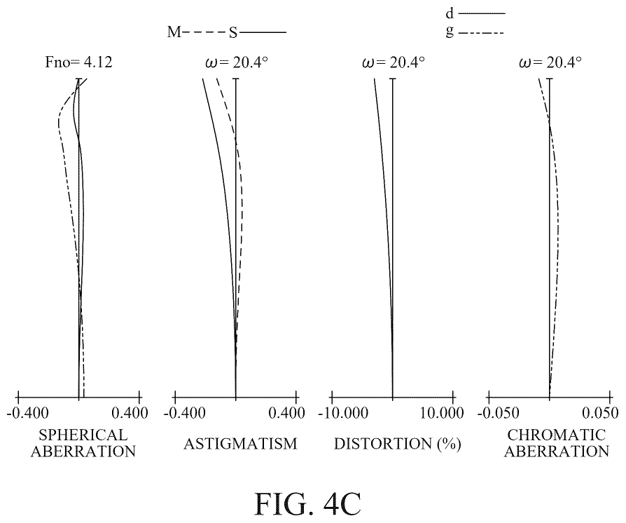

FIGS. 4A, 4B, and 4C illustrate the longitudinal aberration of the zoom lens L0 according to numerical example 2 at the wide-angle end in the in-focus state at infinity.

### Example 3

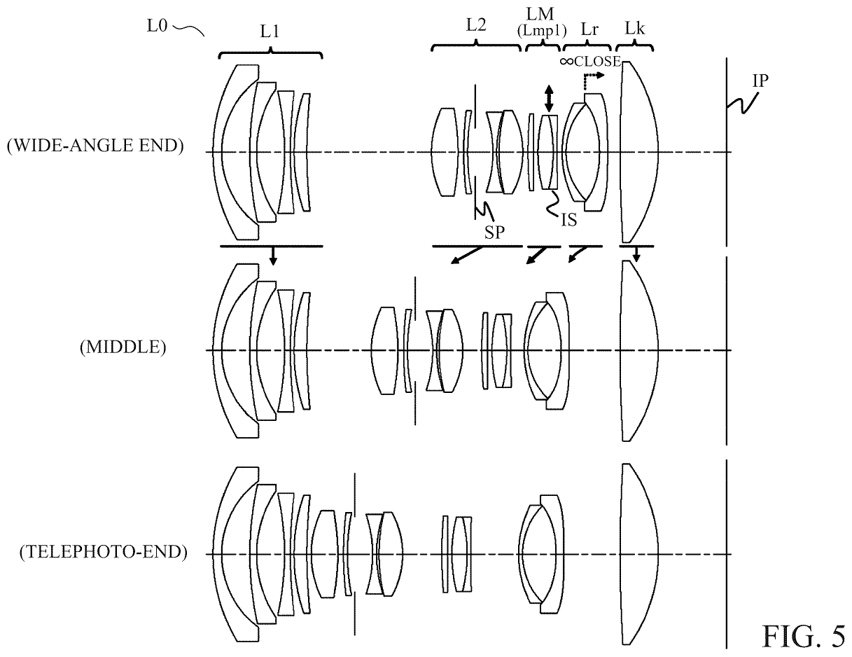

A zoom lens L0 according to Example 3 (numerical example 3) illustrated in FIG. 5 includes, in order from the object side to the image side, a first lens unit L1 with negative refractive power, a second lens unit L2 with positive refractive power including an aperture stop SP, a first intermediate lens unit Lmp1 with positive refractive power, a rear lens unit Lr with negative refractive power, and a final lens unit Lk with positive refractive power. The intermediate group LM includes the first intermediate lens unit Lmp1, and the N-th intermediate lens unit is the first intermediate lens unit Lmp1.

During zooming, the first lens unit L1 and the final lens unit Lk are fixed relative to the image plane IP. During zooming from the wide-angle end to the telephoto end, all of the second lens unit L2, the first intermediate lens unit Lmp1, and the rear lens unit Lr move monotonically toward the object side. During focusing from infinity to a close distance, the rear lens unit Lr moves toward the image side. The cemented lens disposed closest to the image plane in the first intermediate lens unit Lmp1 moves in a direction orthogonal to the optical axis as an image stabilizing unit IS.

The first lens unit L1 includes four lens elements, which include, in order from the object side to the image side, a first negative meniscus lens convex toward the object side, a second negative meniscus lens convex toward the object side, a biconcave negative lens, and a positive meniscus lens convex toward the object side. The second lens unit L2 includes the aperture stop SP and four lens elements. More specifically, the second lens unit L2 includes, in order from the object side to the image side, a biconvex positive lens with aspheric surfaces on both sides, a negative meniscus lens convex toward the object side, the aperture stop SP, a biconcave negative lens, and a biconvex positive lens.

The first intermediate lens unit Lmp1 includes two lens elements, which include, in order from the object side to the image side, a biconvex positive lens and a positive cemented lens consisting of a biconvex positive lens and a biconcave negative lens cemented together. The rear lens unit Lr includes two lens elements, which include, in order from the object side to the image side, a negative meniscus lens convex toward the object side, and a negative meniscus lens convex toward the image side with aspheric surfaces on both sides. The final lens unit Lk includes one lens element that is a biconvex positive lens.

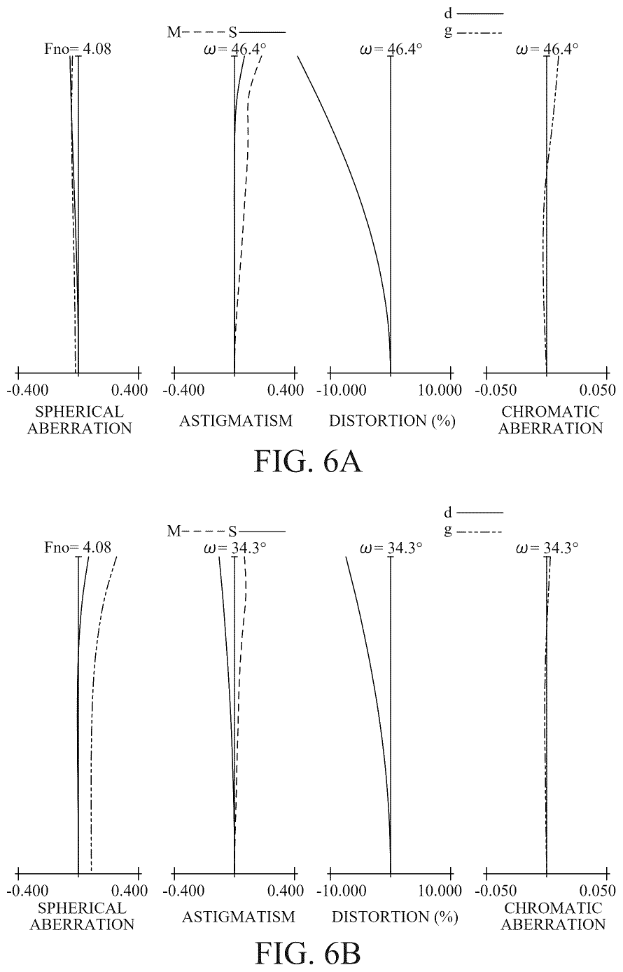

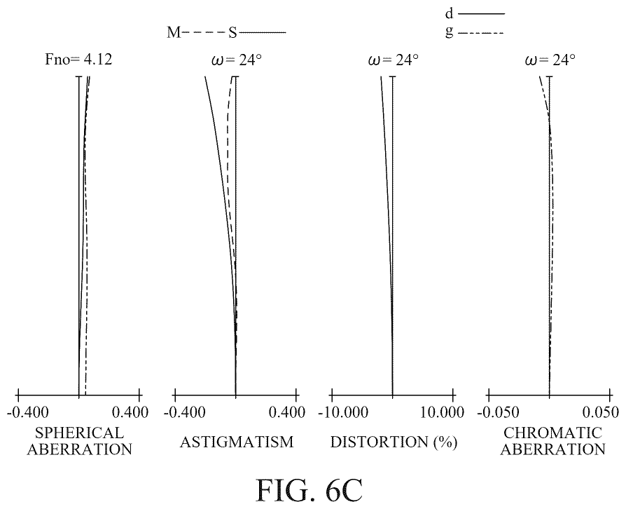

FIGS. 6A, 6B, and 6C illustrate the longitudinal aberration of the zoom lens L0 according to numerical example 3 at the wide-angle end in the in-focus state at infinity.

### Example 4

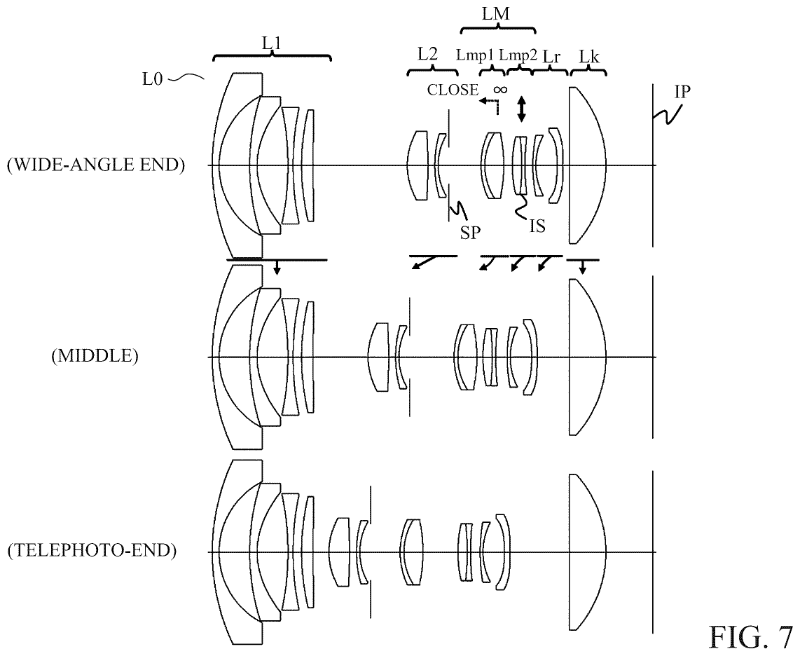

A zoom lens L0 according to Example 4 (numerical example 4) illustrated in FIG. 7 includes, in order from the object side to the image side, a first lens unit L1 with negative refractive power, a second lens unit L2 with positive refractive power including an aperture stop SP, a first intermediate lens unit Lmp1 with positive refractive power, a second intermediate lens unit Lmp2 with positive refractive power, a rear lens unit Lr with negative refractive power, and a final lens unit Lk with positive refractive power. The intermediate group LM includes the first intermediate lens unit Lmp1 and the second intermediate lens unit Lmp2, and the N-th intermediate lens unit is the second intermediate lens unit Lmp2.

During zooming, the first lens unit L1 and the final lens unit Lk are fixed relative to the image plane IP. During zooming from the wide-angle end to the telephoto end, all of the second lens unit L2, the first intermediate lens unit Lmp1, the second intermediate lens unit Lmp2, and the rear lens unit Lr move monotonically toward the object side. During focusing from infinity to a close distance, the first intermediate lens unit Lmp1 moves toward the object side. The entire second intermediate lens unit Lmp2 including its element disposed closest to the image plane serves wholly as an image stabilizing unit IS and moves in a direction orthogonal to the optical axis.

The first lens unit L1 includes four lens elements, which include, in order from the object side to the image side, a first negative meniscus lens convex toward the object side, a second negative meniscus lens convex toward the object side with an aspheric surface on the image side, a biconcave negative lens, and a positive meniscus lens convex toward the object side. The second lens unit L2 includes the aperture stop SP and two lens elements. More specifically, the second lens unit L2 includes, in order from the object side to the image side, a biconvex positive lens element with aspheric surfaces on both sides, a negative meniscus lens element convex toward the object side, and the aperture stop SP.

The first intermediate lens unit Lmp1 includes a single lens element that is a positive cemented lens formed by cementing together a negative meniscus lens convex toward the object side and a biconvex positive lens, arranged in this order from the object side to the image side. The second intermediate lens unit Lmp2 includes a single lens element that is a positive cemented lens formed by cementing together a positive biconvex lens and a negative biconcave lens, arranged in this order from the object side to the image side. The rear lens unit Lr includes two lens elements, which include, in order from the object side to the image side, a negative meniscus lens convex toward the object side and a negative meniscus lens convex toward the image side with aspheric surfaces on both sides. The final lens unit Lk includes a single lens element that is a biconvex positive lens.

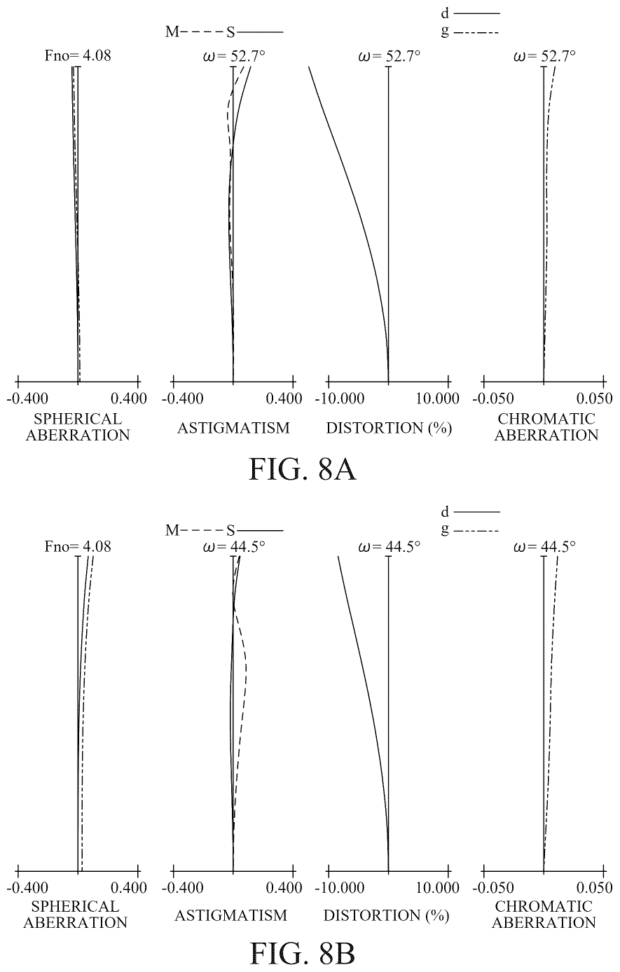

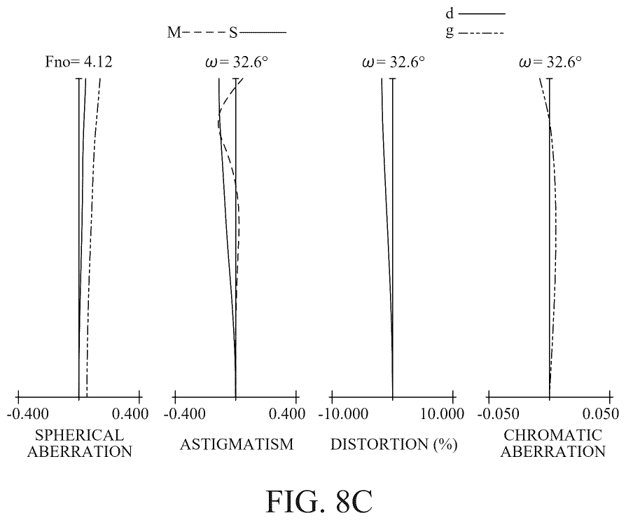

FIGS. 8A, 8B, and 8C illustrate the longitudinal aberration of the zoom lens L0 according to numerical example 4 at the wide-angle end in the in-focus state at infinity.

### Example 5

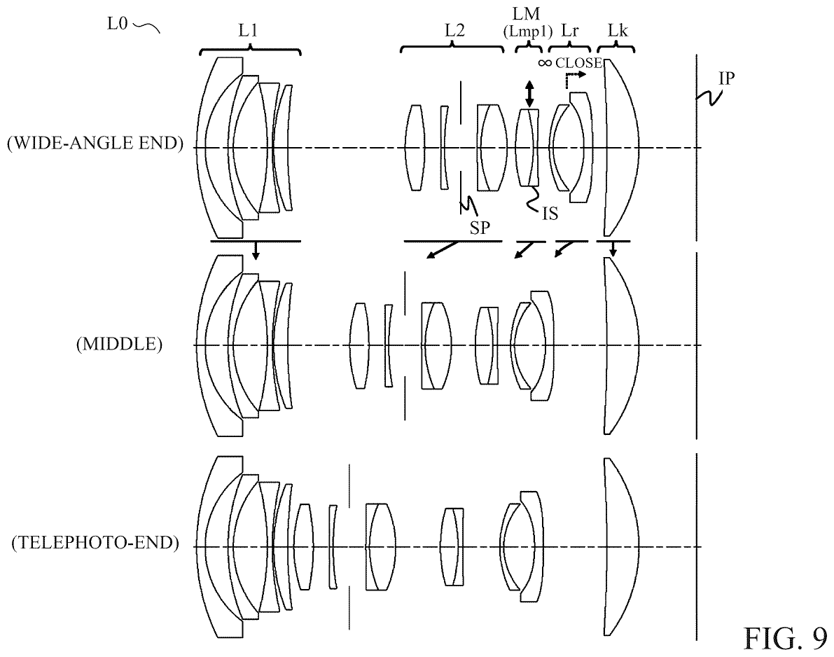

A zoom lens L0 according to Example 5 (numerical example 5) illustrated in FIG. 9 includes, in order from the object side to the image side, a first lens unit L1 with negative refractive power, a second lens unit L2 with positive refractive power including an aperture stop SP, a first intermediate lens unit Lmp1 with positive refractive power, a rear lens unit Lr with negative refractive power, and a final lens unit Lk with positive refractive power. The intermediate group LM includes the first intermediate lens unit Lmp1, and the N-th intermediate lens unit is the first intermediate lens unit Lmp1.

During zooming, the first lens unit L1 and the final lens unit Lk are fixed relative to the image plane IP. During zooming from the wide-angle end to the telephoto end, all of the second lens unit L2, the first intermediate lens unit Lmp1, and the rear lens unit Lr move monotonically toward the object side. During focusing from infinity to a close distance, the rear lens unit Lr moves toward the image side. The first intermediate lens unit Lmp1 including its element disposed closest to the image plane serves wholly as an image stabilizing unit IS and moves in a direction orthogonal to the optical axis.

The first lens unit L1 includes four lens elements, which include, in order from the object side to the image side, a first negative meniscus lens convex toward the object side, a second negative meniscus lens convex toward the object side, a biconcave negative lens, and a positive meniscus lens convex toward the object side. The second lens unit L2 includes the aperture stop SP and three lens elements. More specifically, the second lens unit L2 includes, in order from the object side to the image side, a biconvex positive lens with aspheric surfaces on both sides, a negative meniscus lens convex toward the object side, the aperture stop SP, and a positive cemented lens formed by cementing together a negative meniscus lens convex toward the object side and a biconvex positive lens.

The first intermediate lens unit Lmp1 includes a single lens element that is a positive cemented lens formed by cementing together a biconvex positive lens and a biconcave negative lens, arranged in this order from the object side to the image side. The rear lens unit Lr includes two lens elements, which include, in order from the object side to the image side, a negative meniscus lens convex toward the object side, and a negative meniscus lens convex toward the image side with aspheric surfaces on both sides. The final lens unit Lk includes a single lens element that is a positive meniscus lens convex toward the image side.

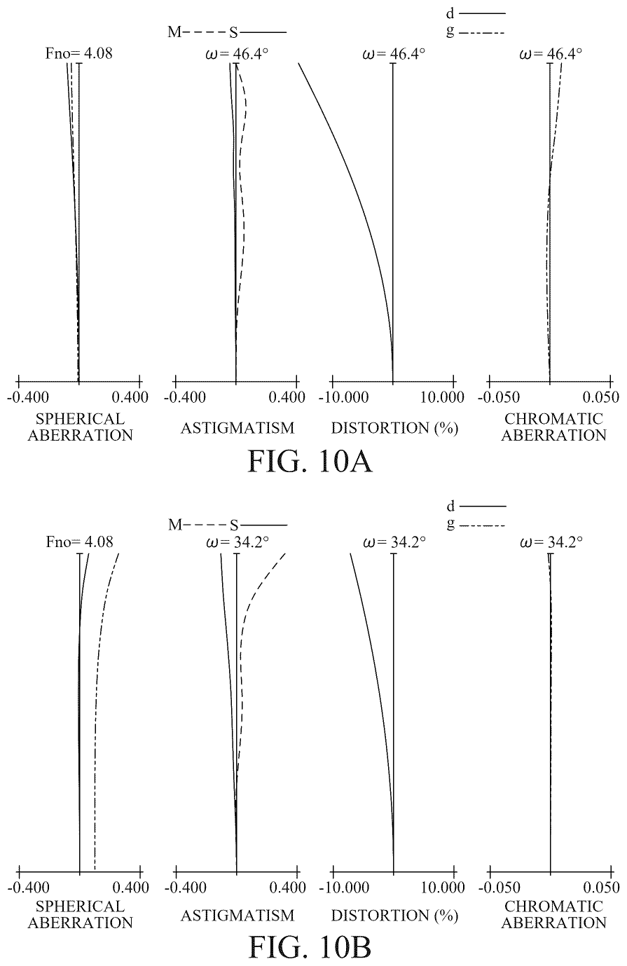

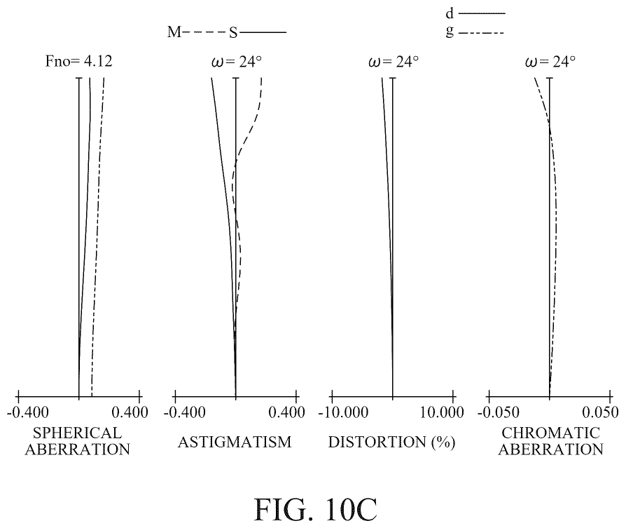

FIGS. 10A, 10B, and 10C illustrate the longitudinal aberration of the zoom lens L0 according to numerical example 5 at the wide-angle end in the in-focus state at infinity.

### Example 6

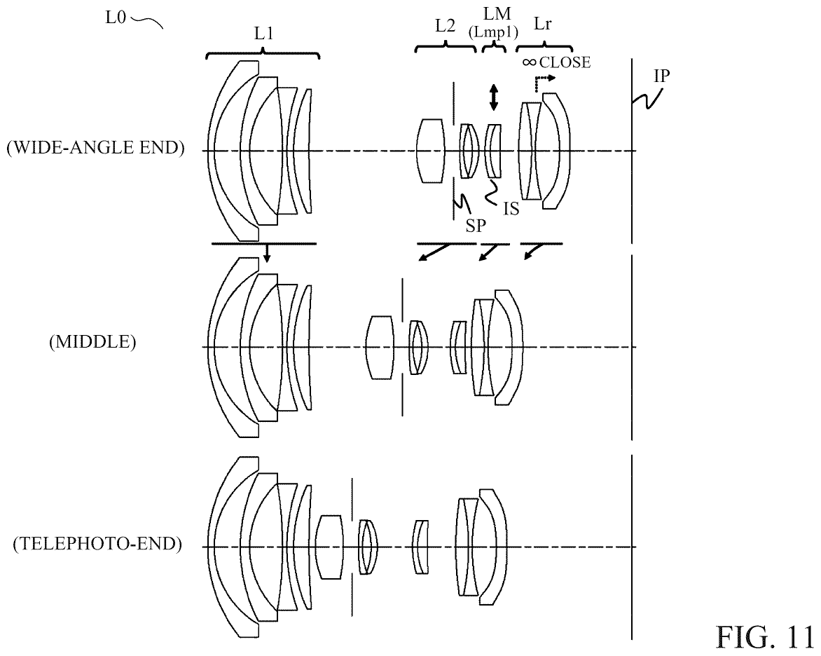

A zoom lens L0 according to Example 6 (numerical example 6) illustrated in FIG. 11 includes, in order from the object side to the image side, a first lens unit L1 with negative refractive power, a second lens unit L2 with positive refractive power including an aperture stop SP, a first intermediate lens unit Lmp1 with positive refractive power, and a rear lens unit Lr with negative refractive power. The zoom lens L0 according to this example has no final lens unit. The intermediate group LM includes the first intermediate lens unit Lmp1, and the N-th intermediate lens unit is the first intermediate lens unit Lmp1.

During zooming, the first lens unit L1 is fixed relative to the image plane IP. During zooming from the wide-angle end to the telephoto end, all of the second lens unit L2, the first intermediate lens unit Lmp1, and the rear lens unit Lr move monotonically toward the object side. During focusing from infinity to a close distance, the rear lens unit Lr moves toward the image side. The first intermediate lens unit Lmp1 including its element disposed closest to the image plane serves wholly as an image stabilizing unit IS and moves in a direction orthogonal to the optical axis.

The first lens unit L1 includes four lens elements, which include, in order from the object side to the image side, a first negative meniscus lens convex toward the object side, a second negative meniscus lens convex toward the object side, a biconcave negative lens, and a positive meniscus lens convex toward the object side. The second lens unit L2 includes the aperture stop SP and three lens elements. The second lens unit L2 includes, in order from the object side to the image side, a biconvex positive lens with aspheric surfaces on both sides, the aperture stop SP, a negative meniscus lens convex toward the object side, and a positive meniscus lens convex toward the image side.

The first intermediate lens unit Lmp1 includes a single lens element that is a positive cemented lens formed by cementing together a negative meniscus lens convex toward the object side and a positive meniscus lens convex toward the object side, arranged in this order from the object side to the image side. The rear lens unit Lr includes two lens elements, which include, in order from the object side to the image side, a negative cemented meniscus lens formed by cementing a biconvex positive lens and a biconcave negative lens, and a negative meniscus lens that is a plastic lens with aspheric surfaces on both sides and is convex toward the image side.

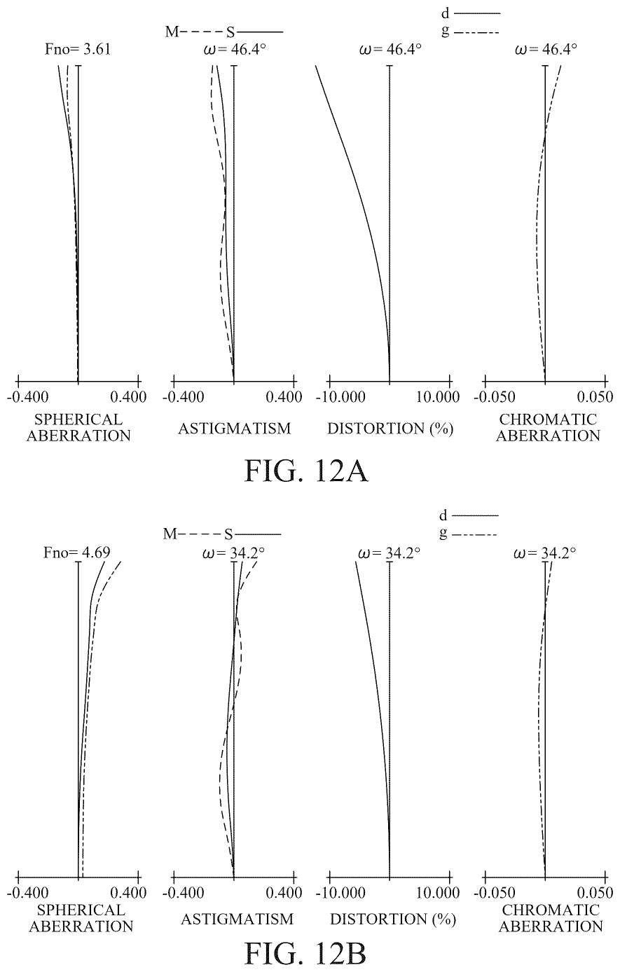

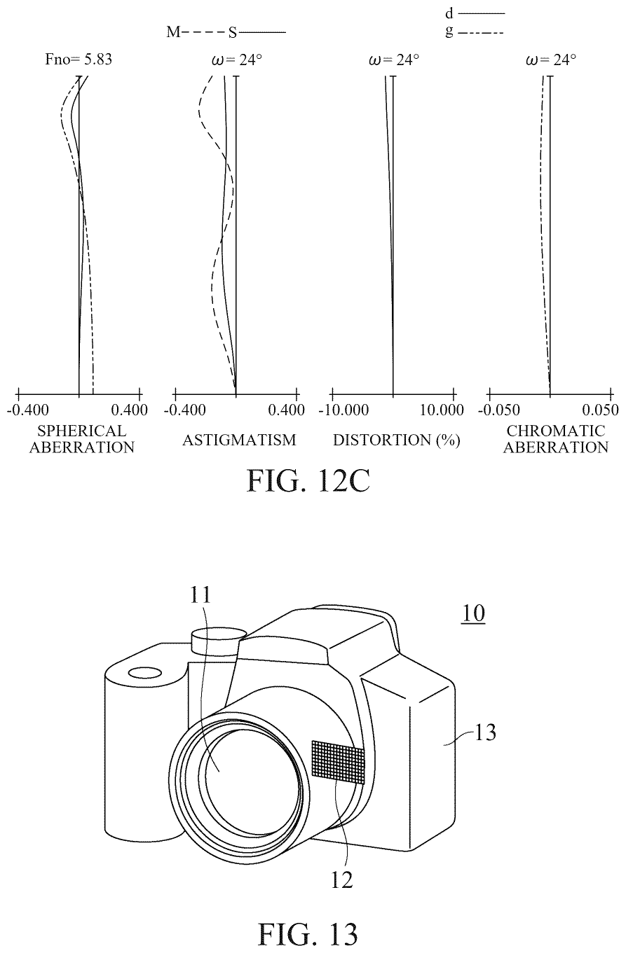

FIGS. 12A, 12B, and 12C illustrate the longitudinal aberration of the zoom lens L0 according to numerical example 6 at the wide-angle end in the in-focus state at infinity.

Numerical examples 1 to 6 will be illustrated below. In surface data for each numerical example, a surface number i indicates the order of an optical surface counted from the object side, r represents a radius of curvature of the i-th surface, and d (mm) indicates an on-axis distance (distance on the optical axis) between i-th and (i+1)-th surfaces. nd indicates a refractive index for the d-line (587.6 nm) of an optical material between i-th and (i+1)-th surfaces, and νd indicates an Abbe number of an optical material based on the d-line. The Abbe number νd based on the d-line is expressed as follows:

$$v d = ( Nd - 1 ) / ( NF - NC )$$

where Nd, NF, and NC are refractive indices for the d-line, F-line (486.1 nm), and C-line (656.3 nm), respectively.

The focal length (mm), F-number, and half angle of view (°) have values in the in-focus state at infinity. The back focus BF is the air-equivalent distance on the optical axis from the lens surface closest to the image plane (final surface) of a zoom lens to the image plane. The overall optical length is a distance on the optical axis from the lens surface closest to the object to the final surface of the zoom lens plus the back focus BF.

An asterisk * next to a surface number indicates that the lens surface is aspherical. The aspheric shape is expressed as follows:

$$x = ( {h}^{2} / R ) / [ 1 + {\{ 1 - ( 1 + K ) {( h / R )}^{2} \}}^{1 / 2} ] + A 4 \times {h}^{4} + A 6 \times {h}^{6} + A 8 \times {h}^{8} + A 10 \times {h}^{10} + A 12 \times {h}^{12}$$

where x is a displacement amount from a surface vertex in the optical axis direction, h is a height from the optical axis in a direction orthogonal to the optical axis, R is a paraxial radius of curvature, K is a conic constant, and A4, A6, A8, . . . are aspheric coefficients of each order. “e±XX” in the conic constant and aspheric coefficients means “x10^{±XX}.”

### Numerical Example 1

UNIT: mm
SURFACE DATA

| Surface No. | r | d | nd | νd |
|---|---|---|---|---|
| 1 | 48.788 | 2.00 | 1.80400 | 46.5 |
| 2 | 21.860 | 5.64 | | |
| 3 | 57.046 | 1.74 | 1.72916 | 54.7 |
| 4 | 23.770 | 7.35 | | |
| 5 | −54.146 | 1.36 | 1.49700 | 81.7 |
| 6 | 170.908 | 0.61 | | |
| 7 | 44.960 | 3.16 | 1.90110 | 27.1 |
| 8 | 171.520 | (Variable) | | |
| 9* | 23.768 | 6.51 | 1.58313 | 59.4 |
| 10* | −38.363 | 4.07 | | |
| 11 (SP) | ∞ | 2.16 | | |
| 12 | −64.016 | 0.90 | 1.73800 | 32.3 |
| 13 | 30.388 | 2.63 | | |
| 14 | 108.662 | 4.69 | 1.49700 | 81.7 |
| 15 | −20.020 | (Variable) | | |
| 16 | 26.181 | 1.05 | 1.72047 | 34.7 |
| 17 | 18.469 | 3.58 | 1.49700 | 81.7 |
| 19 | 24.431 | 1.20 | 1.80400 | 46.5 |
| 20 | 16.770 | 7.15 | | |
| 21* | −34.605 | 1.70 | 1.58313 | 59.4 |
| 22* | −990.655 | (Variable) | | |
| 23 | −168.002 | 7.73 | 1.67300 | 38.1 |
| 24 | −33.001 | 13.50 | | |
| Image Plane | ∞ | | | |

ASPHERIC DATA
9th Surface
K = 0.00000e+00 A 4 = −1.65323e−05 A 6 = −3.34095e−08 A 8= 1.98795e−10
A10 = −3.25473e−12
10th Surface
K = 0.00000e+00 A 4 = 1.36050e−05 A 6 = −3.75284e−08 A 8 = 2.12565e−10
A10 = −3.23024e−12
21st Surface
K = 0.00000e+00 A 4 = −1.18164e−04 A 6 = 2.73264e−07 A 8 = −2.67312e−09
A10 = 8.38987e−12
22nd Surface
K = 0.00000e+00 A 4 = −9.89605e−05 A 6 = 3.76549e−07 A 8 = −1.73256e−09
A10 = 4.12838e−12

VARIOUS DATA
ZOOM RATIO 2.35

| | WIDE | MIDDLE | TELE |
|---|---|---|---|
| Focal Length | 20.60 | 31.67 | 48.50 |
| Fno | 4.08 | 4.08 | 4.12 |
| Half Angle of View (°) | 41.81 | 32.43 | 23.57 |
| Image Height | 18.43 | 20.12 | 21.16 |
| Optical Overall Length | 114.20 | 114.20 | 114.20 |
| BF | 13.50 | 13.50 | 13.50 |
| d8 | 27.74 | 14.95 | 2.17 |
| d15 | 1.55 | 5.01 | 9.40 |
| d18 | 2.45 | 2.55 | 7.77 |
| d22 | 3.74 | 12.97 | 16.15 |

LENS UNIT DATA

| Lens Unit | Starting Surface | Focal Length |
|---|---|---|
| 1 | 1 | −28.76 |
| 2 | 9 | 31.90 |
| 3 | 16 | 85.78 |
| 4 | 19 | −31.75 |
| 5 | 23 | 59.65 |

### Numerical Example 2

UNIT: mm
SURFACE DATA

| Surface No. | r | d | nd | νd |
|---|---|---|---|---|
| 1 | 51.999 | 1.50 | 1.76450 | 49.1 |
| 2* | 21.707 | 7.13 | | |
| 3 | 89.782 | 1.50 | 1.72916 | 54.7 |
| 4 | 33.747 | 6.96 | | |
| 5 | −46.940 | 1.00 | 1.43875 | 94.7 |
| 6 | 481.579 | 0.15 | | |
| 7 | 48.882 | 3.08 | 1.90110 | 27.1 |
| 8 | 172.633 | (Variable) | | |
| 9* | 25.608 | 6.60 | 1.58313 | 59.4 |
| 10* | −45.641 | 1.90 | | |
| 11 | 743.905 | 3.43 | 1.59282 | 68.6 |
| 12 | −32.695 | 0.78 | | |
| 13 | −33.591 | 0.90 | 1.67300 | 38.3 |
| 14 | 27.082 | 3.62 | | |
| 15 (SP) | 8 | 1.50 | | |
| 16 | ∞ | 4.76 | 1.49700 | 81.7 |
| 17* | −22.237 | (Variable) | | |
| 18 | 39.639 | 0.90 | 1.85478 | 24.8 |
| 19 | 23.350 | 2.82 | 1.72916 | 54.7 |
| 20 | 153.745 | (Variable) | | |
| 21 | 38.314 | 1.79 | 1.92286 | 20.9 |
| 22 | −299.310 | 0.90 | 1.87400 | 35.3 |
| 23 | 18.641 | (Variable) | | |
| 24 | −19.345 | 1.00 | 1.85478 | 24.8 |
| 25 | −25.976 | (Variable) | | |
| 26 | −339.660 | 8.22 | 1.59282 | 68.6 |
| 27 | −33.588 | 21.75 | | |
| Image Plane | ∞ | | | |

ASPHERIC DATA
2nd Surface
K = 0.00000e+00 A 4 = 1.00150e−07 A 6 = −7.95946e−10 A 8 = −4.40810e−12
A10 = −4.57871e−15
9th Surface
K = 0.00000e+00 A 4 = −8.41099e−06 A 6 = −1.53412e−09 A 8 = 1.04408e−10
10th Surface
K = 0.00000e+00 A 4 = 2.26558e−05 A 6 = −1.07080e−08 A 8 = 2.06328e−10
A10 = −1.62470e−13
17th Surface
K = 0.00000e+00 A 4 = −4.76412e−06 A 6 = 2.31973e−09 A 8 = −1.06887e−10

VARIOUS DATA
ZOOM RATIO 2.83

| | WIDE | MIDDLE | TELE |
|---|---|---|---|
| Focal Length | 20.60 | 34.01 | 58.20 |
| Fno | 4.08 | 4.08 | 4.12 |
| Half Angle of View (°) | 41.80 | 30.66 | 19.84 |
| Image Height | 18.42 | 20.16 | 21.00 |
| Optical Overall Length | 130.00 | 130.00 | 130.00 |
| BF | 21.75 | 21.75 | 21.75 |
| d8 | 36.95 | 19.22 | 1.50 |
| d17 | 1.50 | 3.79 | 8.83 |
| d20 | 1.40 | 1.50 | 6.77 |
| d23 | 5.76 | 9.23 | 12.56 |
| d25 | 2.19 | 14.05 | 18.14 |

LENS UNIT DATA

| Lens Unit | Starting Surface | Focal Length |
|---|---|---|
| 1 | 1 | −32.14 |
| 2 | 9 | 33.97 |
| 3 | 18 | 85.67 |
| 4 | 21 | −47.52 |
| 5 | 24 | −95.28 |
| 6 | 26 | 62.25 |

### Numerical Example 3

UNIT: mm
SURFACE DATA

| Surface No. | r | d | nd | νd |
|---|---|---|---|---|
| 1 | 38.683 | 2.00 | 1.80400 | 46.5 |
| 2 | 20.802 | 6.54 | | |
| 3 | 73.788 | 1.55 | 1.72916 | 54.7 |
| 4 | 25.722 | 6.47 | | |
| 5 | −62.919 | 1.32 | 1.49700 | 81.7 |
| 6 | 103.148 | 0.92 | | |
| 7 | 42.445 | 2.95 | 1.90110 | 27.1 |
| 8 | 126.306 | (Variable) | | |
| 9* | 22.231 | 6.18 | 1.58313 | 59.4 |
| 10* | −45.825 | 1.29 | | |
| 11 | 79.640 | 0.90 | 1.84666 | 23.8 |
| 12 | 47.541 | 1.81 | | |
| 13 (SP) | ∞ | 4.04 | | |
| 14 | −28.316 | 0.90 | 1.61340 | 44.3 |
| 15 | 28.571 | 0.57 | | |
| 16 | 37.913 | 5.48 | 1.49700 | 81.7 |
| 17 | −19.922 | (Variable) | | |
| 18 | 90.838 | 1.34 | 1.59282 | 68.6 |
| 19 | −4278.940 | 1.00 | | |
| 20 | 35.624 | 3.49 | 1.49700 | 81.7 |
| 21 | −35.409 | 0.90 | 1.51742 | 52.4 |
| 22 | 292.259 | (Variable) | | |
| 23 | 24.507 | 0.90 | 1.51742 | 52.4 |
| 24 | 15.568 | 7.77 | | |
| 25* | −29.839 | 1.85 | 1.58313 | 59.4 |
| 26* | −999.757 | (Variable) | | |
| 27 | 365.125 | 8.79 | 1.59282 | 68.6 |
| 28 | −35.559 | | | |
| Image Plane | ∞ | | | |

ASPHERIC DATA
9th Surface
K = 0.00000e+00 A 4 = −8.96326e−06 A 6 = −8.23607e−09 A 8 = 9.36610e−11
A10 = 9.97060e−13
10th Surface
K = 0.00000e+00 A 4 = 1.59324e−05 A 6 = −9.97104e−09 A 8 = 1.64378e−10
A10 = 7.44975e−13
25th Surface
K = 0.00000e+00 A 4 = −8.00313e−05 A 6 = 3.83989e−07 A 8 = −1.68600e−09
A10 = −5.87468e−12 A12 = 4.26853e−15
26th Surface
K = 0.00000e+00 A 4 = −6.80403e−05 A 6 = 4.28544e−07 A 8 = −2.28917e−09
A10 = 3.59189e−12

VARIOUS DATA
ZOOM RATIO 2.35

| | WIDE | MIDDLE | TELE |
|---|---|---|---|
| Focal Length | 20.60 | 31.74 | 48.50 |
| Fno | 4.08 | 4.08 | 4.12 |
| Half Angle of View (°) | 41.59 | 32.25 | 23.64 |
| Image Height | 18.28 | 20.03 | 21.23 |
| Optical Overall Length | 119.00 | 119.00 | 119.00 |
| BF | 15.83 | 15.83 | 15.83 |
| d8 | 28.85 | 14.93 | 1.00 |
| d17 | 1.20 | 4.42 | 9.09 |
| d22 | 1.20 | 3.06 | 11.05 |
| d26 | 2.96 | 11.81 | 13.07 |

LENS UNIT DATA

| Lens Unit | Starting Surface | Focal Length |
|---|---|---|
| 1 | 1 | −28.94 |
| 2 | 9 | 36.66 |
| 3 | 18 | 54.76 |
| 4 | 23 | −31.12 |
| 5 | 27 | 55.11 |

### Numerical Example 4

UNIT: mm
SURFACE DATA

| Surface No. | r | d | nd | νd |
|---|---|---|---|---|
| 1 | 57.022 | 1.80 | 1.69680 | 55.5 |
| 2 | 20.997 | 8.21 | | |
| 3 | 59.665 | 2.00 | 1.58313 | 59.4 |
| 4* | 20.341 | 8.28 | | |
| 5 | −73.192 | 1.32 | 1.49700 | 81.7 |
| 6 | 71.955 | 2.32 | | |
| 7 | 63.529 | 3.14 | 1.85478 | 24.8 |
| 8 | 1232.658 | (Variable) | | |
| 9* | 17.150 | 5.55 | 1.58313 | 59.4 |
| 10* | −114.655 | 1.84 | | |
| 11 | 30.561 | 0.90 | 1.95375 | 32.3 |
| 12 | 16.319 | 2.84 | | |
| 13 (SP) | ∞ | (Variable) | | |
| 14 | 20.477 | 1.03 | 1.85025 | 30.1 |
| 15 | 15.969 | 5.09 | 1.43875 | 94.7 |
| 16 | −39.822 | (Variable) | | |
| 17 | 33.337 | 2.50 | 1.80400 | 46.5 |
| 18 | −66.497 | 0.90 | 1.67300 | 38.3 |
| 19 | 68.546 | (Variable) | | |
| 20 | 42.517 | 0.80 | 1.77250 | 49.6 |
| 21 | 17.124 | 5.72 | | |
| 22* | −63.079 | 1.50 | 1.76450 | 49.1 |
| 23* | −790.654 | (Variable) | | |
| 24 | 9305.694 | 9.76 | 1.49700 | 81.5 |
| 25 | −30.835 | 12.50 | | |
| Image Plane | ∞ | | | |

ASPHERIC DATA
4th Surface
K = 0.00000e+00 A 4 = −1.29206e−05 A 6 = −3.33436e−08 A 8 = 4.08273e−11
A10 = −2.59124e−13
9th Surface
K = 0.00000e+00 A 4 = −1.87286e−05 A 6 = −7.74645e−08 A 8 = 3.20153e−10
A10 = −2.29951e−12
10th Surface
K = 0.00000e+00 A 4 = 9.75513e−06 A 6 = −6.27042e−08 A 8 = 5.60291e−10
A10 = −2.83944e−12
22nd Surface
K = 0.00000e+00 A 4 = −2.70692e−04 A 6 = 9.74607e−07 A 8 = −6.71740e−09
A10 = −9.42909e−12
23rd Surface
K = 0.00000e+00 A 4 = −2.31475e−04 A 6 = 1.38855e−06 A 8 = −8.90312e−09
A10 = 2.93218e−11

VARIOUS DATA
ZOOM RATIO 2.06

| | WIDE | MIDDLE | TELE |
|---|---|---|---|
| Focal Length | 16.48 | 22.07 | 33.95 |
| Fno | 4.08 | 4.08 | 4.12 |
| Half Angle of View (°) | 48.69 | 41.99 | 32.09 |
| Image Height | 18.75 | 19.87 | 21.28 |
| Optical Overall Length | 118.00 | 118.00 | 118.00 |
| BF | 12.50 | 12.50 | 12.50 |
| d8 | 25.19 | 14.69 | 4.18 |
| d13 | 8.64 | 11.91 | 7.97 |
| d16 | 2.29 | 1.65 | 9.38 |
| d19 | 2.10 | 3.10 | 2.52 |
| d23 | 1.80 | 8.67 | 15.96 |

LENS UNIT DATA

| Lens Unit | Starting Surface | Focal Length |
|---|---|---|
| 1 | 1 | −23.80 |
| 2 | 9 | 55.15 |
| 3 | 14 | 37.77 |
| 4 | 17 | 59.99 |
| 5 | 20 | −25.45 |
| 6 | 24 | 61.86 |

### Numerical Example 5

UNIT: mm
SURFACE DATA

| Surface No. | r | d | nd | νd |
|---|---|---|---|---|
| 1 | 46.953 | 2.00 | 1.80400 | 46.5 |
| 2 | 21.356 | 5.35 | | |
| 3 | 42.819 | 1.25 | 1.61800 | 63.4 |
| 4 | 22.934 | 7.93 | | |
| 5 | −58.865 | 1.19 | 1.49700 | 81.7 |
| 6 | 65.541 | 0.31 | | |
| 7 | 38.855 | 3.27 | 1.90110 | 27.1 |
| 8 | 104.133 | (Variable) | | |
| 9* | 29.845 | 4.56 | 1.58313 | 59.4 |
| 10* | −44.171 | 3.70 | | |
| 11 | 446.638 | 0.90 | 1.76182 | 26.5 |
| 12 | 53.635 | 3.75 | | |
| 13 (SP) | ∞ | 3.91 | | |
| 14 | 800.000 | 0.85 | 1.61340 | 44.3 |
| 15 | 25.168 | 6.12 | 1.49700 | 81.7 |
| 16 | −24.238 | (Variable) | | |
| 17 | 32.742 | 4.13 | 1.49700 | 81.7 |
| 18 | −32.972 | 1.05 | 1.51742 | 52.4 |
| 19 | 191.981 | (Variable) | | |
| 20 | 23.012 | 0.90 | 1.51633 | 64.1 |
| 21 | 14.870 | 7.20 | | |
| 22* | −26.367 | 2.00 | 1.58313 | 59.4 |
| 23* | −300.000 | (Variable) | | |
| 24 | −322.629 | 7.53 | 1.65160 | 58.5 |
| 25 | −34.000 | 13.50 | | |
| Image Plane | ∞ | | | |

ASPHERIC DATA
9th Surface
K = 0.00000e+00 A 4 = −1.22200e−05 A 6 = −1.30528e−08 A 8 = 1.66705e−10
A10 = 1.61469e−14
10th Surface
K = 0.00000e+00 A 4 = 9.41880e−06 A 6 = −1.21827e−08 A 8 = 1.93208e−10
22nd Surface
K = 0.00000e+00 A 4 = −6.57431e−05 A 6 = 1.62758e−07 A 8 = 1.15618e−09
A10 = −8.17630e−11 A12 = 4.61761e−13
23rd Surface
K = 0.00000e+00 A 4 = −5.36868e−05 A 6 = 3.36296e−07 A 8 = −3.43301e−09
A10 = 1.01095e−11

VARIOUS DATA
ZOOM RATIO 2.35

| | WIDE | MIDDLE | TELE |
|---|---|---|---|
| Focal Length | 20.60 | 31.77 | 48.50 |
| Fno | 4.08 | 4.08 | 4.12 |
| Half Angle of View (°) | 41.54 | 32.30 | 23.66 |
| Image Height | 18.25 | 20.09 | 21.25 |
| Optical Overall Length | 116.79 | 116.79 | 116.79 |
| BF | 13.50 | 13.50 | 13.50 |
| d8 | 27.43 | 14.43 | 1.43 |
| d16 | 1.95 | 5.56 | 10.42 |
| d19 | 2.69 | 3.09 | 8.72 |
| d23 | 3.33 | 12.32 | 14.83 |

LENS UNIT DATA

| Lens Unit | Starting Surface | Focal Length |
|---|---|---|
| 1 | 1 | −28.28 |
| 2 | 9 | 32.51 |
| 3 | 17 | 83.12 |
| 4 | 20 | −29.98 |
| 5 | 24 | 57.73 |

### Numerical Example 6

UNIT: mm
SURFACE DATA

| Surface No. | r | d | nd | νd |
|---|---|---|---|---|
| 1 | 33.149 | 1.50 | 1.95375 | 32.3 |
| 2 | 20.747 | 6.16 | | |
| 3 | 37.514 | 2.20 | 1.91082 | 35.2 |
| 4 | 20.517 | 7.76 | | |
| 5 | −86.146 | 1.00 | 1.49700 | 81.7 |
| 6 | 44.315 | 1.58 | | |
| 7 | 34.512 | 3.58 | 1.85478 | 24.8 |
| 8 | 164.815 | (Variable) | | |
| 9* | 17.447 | 6.60 | 1.58313 | 59.4 |
| 10* | −35.367 | 2.08 | | |
| 11 (SP) | ∞ | 1.50 | | |
| 12 | 46.292 | 0.90 | 1.85451 | 25.2 |
| 13 | 16.328 | 2.07 | | |
| 14 | −16.613 | 1.47 | 1.49700 | 81.7 |
| 15 | −12.326 | (Variable) | | |
| 16 | 21.750 | 1.20 | 1.73800 | 32.3 |
| 17 | 15.280 | 2.28 | 1.49700 | 81.7 |
| 18 | 89.083 | (Variable) | | |
| 19 | 75.588 | 3.00 | 1.84666 | 23.9 |
| 20 | −54.732 | 0.90 | 1.95375 | 32.3 |
| 21 | 47.079 | 5.67 | | |
| 22* | −40.258 | 2.50 | 1.53504 | 55.7 |
| 23* | −90.102 | (Variable) | | |
| Image Plane | ∞ | | | |

ASPHERIC DATA
9th Surface
K = 0.00000e+00 A 4 = −4.03996e−05 A 6 = −1.61494e−07 A 8 = −1.09460e−09
A10 = −1.16939e−11
10th Surface
K = 0.00000e+00 A 4 = 2.15083e−05 A 6 = −1.76542e−07 A 8 = −1.96137e−09
A10 = 3.48352e−12
22nd Surface
K = 0.00000e+00 A 4 = −8.94279e−05 A 6 = −8.41145e−07 A 8 = 4.86754e−09
23rd Surface
K = 0.00000e+00 A 4 = −8.02127e−05 A 6 = −3.42404e−07 A 8 = 2.28946e−09
A10 = −6.59050e−13

VARIOUS DATA
ZOOM RATIO 2.35

| | WIDE | MIDDLE | TELE |
|---|---|---|---|
| Focal Length | 20.60 | 31.82 | 48.50 |
| Fno | 3.61 | 4.69 | 5.83 |
| Half Angle of View (°) | 42.64 | 32.68 | 23.77 |
| Image Height | 18.97 | 20.41 | 21.36 |
| Optical Overall Length | 99.74 | 99.74 | 99.74 |
| BF | 14.49 | 25.65 | 29.35 |
| d8 | 25.32 | 13.41 | 1.50 |
| d15 | 1.50 | 5.23 | 8.27 |
| d18 | 4.48 | 1.50 | 6.68 |
| d23 | 14.49 | 25.65 | 29.35 |

LENS UNIT DATA

| Lens Unit | Starting Surface | Focal Length |
|---|---|---|
| 1 | 1 | −31.31 |
| 2 | 9 | 31.46 |
| 3 | 16 | 75.54 |
| 4 | 19 | −55.82 |

Table 1 summarizes values of inequalities (1) to (8) in numerical examples 1 to 6. The zoom lens according to each numerical example satisfies all of inequalities (1) to (8).

| | | ex. 1 | ex. 2 | ex. 3 | ex. 4 | ex. 5 | ex. 6 |
|---|---|---|---|---|---|---|---|
| | fw | 20.60 | 20.60 | 20.60 | 16.48 | 20.60 | 20.60 |
| | TTLw | 114.20 | 130.00 | 119.00 | 118.00 | 116.79 | 99.74 |
| | BFw | 13.50 | 21.75 | 15.83 | 12.50 | 13.50 | 14.49 |
| | f1 | −28.76 | −32.14 | −28.94 | −23.80 | −28.28 | −31.31 |
| | f2 | 31.90 | 33.97 | 36.66 | 55.15 | 32.51 | 31.46 |
| | fN | 85.78 | 85.67 | 54.76 | 59.99 | 83.12 | 75.54 |
| | fis | 85.78 | 85.67 | 85.51 | 59.99 | 83.12 | 75.54 |
| | βist | 0.59 | 0.58 | 0.55 | 0.61 | 0.57 | 0.51 |
| | βisrt | 1.81 | 2.08 | 1.72 | 2.14 | 1.81 | 1.60 |
| | M2 | −25.57 | −35.45 | −27.85 | −21.01 | −26.00 | −23.82 |
| | MN | −17.72 | −28.12 | −19.96 | −14.59 | −17.53 | −17.05 |
| (1) | fis/(−f1) | 2.98 | 2.67 | 2.95 | 2.52 | 2.94 | 2.41 |
| (2) | BFw/fw | 0.66 | 1.06 | 0.77 | 0.76 | 0.66 | 0.70 |
| (3) | fN/(−f1) | 2.98 | 2.67 | 1.89 | 2.52 | 2.94 | 2.41 |
| (4) | (1 − B ist) × Bisrt | 0.75 | 0.88 | 0.77 | 0.84 | 0.77 | 0.78 |
| (5) | \| MN/M2 \| | 0.69 | 0.79 | 0.72 | 0.69 | 0.67 | 0.72 |
| (6) | TTLw/fw | 5.54 | 6.31 | 5.78 | 7.16 | 5.67 | 4.84 |
| (7) | fis/f2 | 2.69 | 2.52 | 2.33 | 1.09 | 2.56 | 2.40 |
| (8) | f2/(−f1) | 1.11 | 1.06 | 1.27 | 2.32 | 1.15 | 1.00 |

### Image Pickup Apparatus

FIG. 13 illustrates a digital still camera (image pickup apparatus) using a zoom lens L0 according to any one of Examples 1 to 6 as its imaging optical system. Reference numeral 10 denotes a camera body, and reference numeral 11 denotes an imaging optical system 11 using one of the zoom lenses L0 according to Examples 1 to 6. Reference numeral 12 denotes an image sensor (photoelectric conversion element), such as a CCD sensor or CMOS sensor, built into the camera body 10, and configured to photoelectrically convert an optical image formed by the imaging optical system 11 (or to capture the object image through the zoom lens). The camera body 10 may be a single-lens reflex camera with a quick-turn mirror, or a mirrorless camera without a quick-turn mirror.

The zoom lens L0 according to each example applied to an image pickup apparatus such as a digital still camera can provide an image pickup apparatus having a reduced size.

An imaging system (e.g., a surveillance camera system) may include the zoom lens L0 according to each example and a control unit configured to control the zoom lens. In this case, the control unit controls a lens unit, a focus lens unit, and the image stabilizing unit IS that are movable during zooming, focusing, and image stabilization. The control unit may not be integrated with the zoom lens L0, and may be separate from the zoom lens L0, so as to remotely control the zoom lens L0.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example according to the disclosure can provide a zoom lens that has a reduced size and can drive a shift unit satisfactorily.

This application claims the benefit of Japanese Patent Application No. 2024-201184, which was filed on Nov. 18, 2024, which is hereby incorporated by reference herein in its entirety.

1. A zoom lens comprising, in order from an object side to an image side:
a first lens unit with negative refractive power;
a second lens unit;
one or more intermediate lens units; and
a rear lens unit,
wherein at least the second lens unit and the one or more intermediate lens units move during zooming and each distance between adjacent lens units changes,
wherein the one or more intermediate lens units include an N-th intermediate lens unit disposed closest to an image plane, and the N-th intermediate lens unit includes a shift unit with positive refractive power disposed closest to the image plane and movable in a direction orthogonal to an optical axis of the zoom lens, and
wherein the following inequalities are satisfied:
$$1. 8 \leq fis / ( - f 1 ) \leq 4.8$$
$$0.05 \leq BFw / fw \leq 1.29$$
where f1 is a focal length of the first lens unit, fis is a focal length of the shift unit, fw is a focal length of the zoom lens at a wide-angle end, and BFw is an air-equivalent distance on the optical axis from a lens surface closest to the image plane of the zoom lens at the wide-angle end to the image plane.

2. The zoom lens according to claim 1, wherein the shift unit includes two or more lenses.

3. The zoom lens according to claim 1, wherein the second lens unit includes two or more lens elements.

4. The zoom lens according to claim 1, wherein the first lens unit is fixed during zooming.

5. The zoom lens according to claim 1, wherein the second lens unit and the one or more intermediate lens units move toward an object during zooming from the wide-angle end to a telephoto end.

6. The zoom lens according to claim 1, wherein four or fewer lens units move during zooming.

7. The zoom lens according to claim 1, wherein the second lens unit has positive refractive power.

8. The zoom lens according to claim 1, wherein the shift unit includes a positive lens and a negative lens.

9. The zoom lens according to claim 1, wherein the shift unit consists of a single lens element.

10. The zoom lens according to claim 1, wherein the first lens unit includes, in order from the object side to the image side, a first meniscus lens with negative refractive power convex toward the object side, and a second meniscus lens with negative refractive power convex toward the object side.

11. The zoom lens according to claim 1, wherein the N-th intermediate lens unit includes three or fewer lenses.

12. The zoom lens according to claim 1, wherein the following inequality is satisfied:
$$0.9 \leq fN / ( - f 1 ) \leq 4.5$$
where fN is a focal length of the N-th intermediate lens unit.

13. The zoom lens according to claim 1, wherein the following inequality is satisfied:
$$0.4 \leq ( 1 - β ist ) \times β isrt \leq 1.45$$
where βist is a lateral magnification of the shift unit at a telephoto end, and βisrt is a lateral magnification of an optical system including all lenses disposed closer to the image plane than the shift unit at the telephoto end.

14. The zoom lens according to claim 1, wherein the following inequality is satisfied:
$$0.4 \leq \vert MN / M 2 \vert \leq 1.2$$
where M2 is a moving amount of the second lens unit during zooming from the wide-angle end to a telephoto end, and MN is a moving amount of the N-th intermediate lens unit during zooming.

15. The zoom lens according to claim 1, wherein the following inequality is satisfied:
$$3. 5 \leq TTLw / fw \leq 8.9$$
where TTLw is an overall optical length calculated by adding BFw to a distance on the optical axis from a lens surface of the zoom lens closest to an object to a lens surface closest to the image plane of the zoom lens at the wide-angle end.

16. The zoom lens according to claim 1, wherein the following inequality is satisfied:
$$1. 0 \leq fis / f 2 \leq 4.5$$
where f2 is a focal length of the second lens unit.

17. The zoom lens according to claim 1, wherein the following inequality is satisfied:
$$0.54 \leq f 2 / ( - f 1 ) \leq 2.35$$
where f2 is a focal length of the second lens unit.

18. The zoom lens according to claim 1, wherein the rear lens unit has negative refractive power.

19. The zoom lens according to claim 1, wherein a final lens unit with positive refractive power that does not move during zooming is disposed closest to the image plane of the zoom lens.

20. The zoom lens according to claim 1, wherein the following inequality is satisfied:
$$1. 93 \leq fis / ( - f 1 ) \leq 4.8 .$$

21. The zoom lens according to claim 3, wherein the following inequality is satisfied:
$$1. 93 \leq fis / ( - f 1 ) \leq 4.8 .$$

22. A zoom lens comprising, in order from an object side to an image side:
a first lens unit with negative refractive power;
a second lens unit;
one or more intermediate lens units; and
a rear lens unit,
wherein at least the second lens unit and the one or more intermediate lens units move during zooming and each distance between adjacent lens units changes, and
wherein the one or more intermediate lens units include an N-th intermediate lens unit disposed closest to an image plane, and the N-th intermediate lens unit includes a shift unit with positive refractive power disposed closest to the image plane and movable in a direction orthogonal to an optical axis of the zoom lens.

23. An image pickup apparatus comprising:
the zoom lens according to claim 1; and
an image sensor configured to capture an object image through the zoom lens.
